(19) United States
(12) Patent Application Publication
(10) Pub. No.: US 2015/0066790 A1
(43) Pub. Date: Mar. 5, 2015

(54) PLATFORM FOR IMAGE FEED AND CHARITABLE DONATION

(71) Applicant: Pixhug Media Inc., Vancouver (CA)

(72) Inventor: Mido Rakocevic DeSanti, Vancouver (CA)

(21) Appl. No.: 14/308,043

(22) Filed: Jun. 18, 2014

Related U.S. Application Data
(60) Provisional application No. 61/873,553, filed on Sep. 4, 2013.

(51) Int. Cl. G06Q 30/02; G06Q 50/00

(52) U.S. Cl. CPC G06Q 30/0279; G06Q 50/01
USPC 705/319

(57) ABSTRACT

Disclosed is a network user action-driven support computation method and system that receives, from a first user, a user image that may then be supplied as a feed on a social network, receives a designation associating a charitable fund with the user image, obtains automatically, as a first value, a number of network user actions entered in response to the user image, for example, by users selecting “like” or sharing the user image, and computes and reports a donation amount to the charitable fund based on the first value. The user images may be electronic photo albums, image albums, or videos of the first user, and may be displayed to users connected on the social network to the first user as an electronic feed that includes an identification of the charitable fund adjacent to or juxtaposed with the user image.

### CROSS-REFERENCE TO RELATED APPLICATION

The present application claims priority to U.S. Provisional Patent Application No. 61/873,553, filed Sep. 4, 2013, the entire contents of, all of which are incorporated by reference herein.

### FIELD OF THE INVENTION

The present invention relates to social network-oriented charitable giving, and, in particular, to social network user action-driven support for charitable organizations, campaigns and funds, and to providing a user feed that includes a user image together with charitable fund identification to friends or connections of the user on the social network.

### BACKGROUND

### Background of the Disclosure

On-line charitable donations and giving have increased in popularity and allow corporate sponsors or donors to choose from a wide range of charities and charitable campaigns to create goodwill for their brands and their corporate identity. However, corporate sponsors often look for ways to penetrate social networking platforms to get their brands or names or company logos or the like in front of users on a regular basis.

At the same time, it is often difficult for an ordinary user to present in a suitable manner a virtual photo album and the photos laid out in the album in a content feed for a social network. Users often find it difficult to collect images, to edit and arrange the layout etc. of the images, and to create feeds for social networks that present the virtual photo album in an attractive manner.

More than 300 million photos are shared on Facebook everyday and these photos garner 2.7 billion “likes” everyday. Thus, the enormous number of feeds shared by users on social networks creates a great potential for charities and sponsors to interact with such users.

Flynn, U.S. Patent Application Publication No. 2010/0010886, describes facilitating and encouraging charitable giving using a social network in which a donation facilitator allows charitable or not-for-profit organizations to encourage donations through advertising on a social network and allows for connecting, tracking and storing donations. Further, Singhal, U.S. Patent Application Publication No. 2012/0173630, describes creating social communities around cause, and then a display on a social network can include text that shows the calls or charity, as well as celebrity status of the originator or the message together with the message. Also, Han, U.S. Pat. No. 8,327,253 describes creating and sharing photo books, including video data, and describes that a user can create a photo book and share it on a social network site. The entire contents of each of these references are incorporated in full by reference herein.

However, there is a need for a method and system that generates donations for a cause based on user actions made on a social network, and that generates such donations by a third party, such as a corporate sponsor, based on user actions on a social network. Also, there is a need for providing in a single combined feed on a social network to connections of a user, a virtual photo album and information or identification of a charity, charity campaign or charitable fund.

### SUMMARY OF THE INVENTION

Disclosed are a network user action-driven support computation method, non-transient computer-readable or processor-readable medium, device, system, and means for accomplishing the below-described effects. Such a method may include: receiving, from a first device connected to the network, a user image viewable on a plurality of second devices connected to the network; receiving, as a first association, a designation by a first user associating a charitable fund with the user image; obtaining automatically, as a first value, a number of network user actions, entered on the plurality of second devices, to the network for the user image; computing automatically, as a donation amount, the network user action-driven support for the charitable fund according to a product of a coefficient and the first value; and outputting automatically the donation amount via the network.

In such a method, the user image may be viewable as a feed provided, by at least one server computing device of a social network, on a page associated with a social network user, and the network user actions are actions by social network users responding to the user image.

In this method, the network user actions may include likes or hugs of the user image provided to social network users connected on the social network to the first user, and/or may include shares or re-postings of the user image provided to social network users connected on the social network to the first user.

Based on the first association, the user image may be displayed on the plurality of second devices adjacent to or juxtaposed with an identification of the charitable fund. The identification of the charitable fund may include, for example, a disclosure that the network user actions entered for the user image generate donation to the charitable fund. The user image may be a virtual photo album or a representation of a virtual photo album, a video, and may include an audio or sound component.

Such a method may also include: receiving, from a sponsor, as a maximum value, a maximum support amount that the sponsor commits to giving to the charitable fund; charging the sponsor a charged amount, the charged amount being the donation amount up to the maximum value; and making a donation to the charitable fund based on the charged amount.

Such a method may further include subtracting from the charged amount a fee amount to yield a net donation amount, wherein the making the donation comprises giving the net donation to the charitable fund.

Based on the first association, the user image is displayed on the plurality of second devices adjacent to or juxtaposed with an identification of the charitable fund; and they may further comprise: displaying an identification of the sponsor adjacent to or juxtaposed with the identification of the charitable fund.

The identification of the sponsor may include displaying the maximum value. Also, a tally in real time of network user action-driven support generated for the charitable fund may be displayed, for example, such that the first user posting the user image and/or the connections on the social network of the first user may view the tally. Such a tally of network user action-drive support generated for the charitable fund in response to the user image may reflect, for example, just the number of network user action-drive support actions generated for this user image of the first user, all the user images of the first user associated with this charitable campaign, all the user images of the first user associated with all charitable campaigns, all user images of the first user, all user images of any user associated with this charitable campaign, all user images of any user associated with this charity, all money raised to date of this charitable campaign, and/or some combination of the foregoing.

The method may further include: displaying identification of a plurality of charitable funds; and receiving, from the first user, the designation associating the charitable fund with the user image, a selection of the charitable fund from the plurality of charitable funds.

The user image may be received directly via the internet from a second server computing device of a second social network in response to a user instruction.

The coefficient may be a pre-set amount designated by the sponsor.

Such a method may further include: receiving from a sponsor as a maximum value, a maximum support amount that the sponsor commits to giving to the charitable fund; and receiving from the sponsor a user restriction restricting a type of user who is permitted to serve as the first user.

According to the method, the user restriction may identify the type of first user by geographic region, and/or the user restriction may identify a type of first user by a demographic criterion.

The method may include: calculating a total number of network user actions entered for the first user in connection with the user image and all user images associated with the first user with which a charitable fund has been associated; and awarding a virtual badge, a virtual medal or a virtual citation viewable on the page associated with the first user, when the total number of network user actions reaches a pre-set amount.

Also described is a network user action-driven support computation system, comprising:

a user image interface configured to receive a user image from a first user;
a designation module configured to receive, as a first association, a designation by the first user associating a charitable fund with the user image;
a feed provider configured to provide the user image viewable as a feed of a social network provided to a plurality of social network users connected on the social network to the first user;
a user action tracking module configured to obtain automatically, as a first value, a number of network user actions entered by the plurality of social network users, wherein the network user actions are actions by the plurality of social network users responding to the user image and comprising at least one of likes, hugs or user actions expressing approval of the user image;
a donation tracking module configured to compute automatically, as a donation amount, the network user action-driven support for the charitable fund according to a product of a coefficient and the first value; and
the donation tracking module further configured to output automatically the donation amount via the network.

In such a system, based on the first association, the feed provider may provide the user image for display on the plurality of second devices adjacent to or juxtaposed with an identification of the charitable fund. For example, the user image may be a virtual photo album or a representation of a virtual photo album.

Such a system may also include a sponsor interface configured to receive, from a sponsor, as a maximum value, a maximum support amount that the sponsor commits to giving to the charitable fund; and a payment processing module configured to charge the sponsor a charged amount, the charged amount being the donation amount up to the maximum value, wherein the donation amount to the charitable fund is based on the charged amount.

Based on the first association, the feed provider may provide the user image for display on the plurality of second devices adjacent to or juxtaposed with an identification of the charitable fund; and the feed provider provides with the user image for display an identification of the sponsor adjacent to or juxtaposed with the identification of the charitable fund.

Also contemplated is a method of generating network user support for a charitable fund, the method comprising:

receiving, from a first device connected to the network, a user image associated with a first user of a social network, the user image viewable by a plurality of second users, the plurality of second users being connections on the social network of the first user;
displaying an identification of a plurality of charitable funds to the first user;
receiving, from the first user, as a designation associating a charitable fund with the user image, a selection of the charitable fund from the plurality of charitable funds; and
displaying together an identification of the charitable fund and the user image as a feed viewable by the plurality of second users on a page of a social network associated with each user of the plurality of second users.

In this method, the user image may be a virtual photo album or representation of the virtual photo album. Such a user image may be imported to at least one server computing device associated with the social network from a first device operated by the first user, in response to an instruction entered by the first user. The user image may be imported to at least one server computing device associated with the social network from a second device remote from the first user and connected to the first user and to the server device associated with the social network via the internet.

The user image may be imported to the server computing device associated with the social network from a second server device associated with a second social network different from the social network. The identification of the charitable fund may be displayed adjacent to or juxtaposed with the user image.

Other features and details of the invention are described below.

### BRIEF DESCRIPTION OF THE FIGURES

FIG. 1 illustrates an example of a feed server and major components interacting with the feed server over the Internet, according to an aspect of the present disclosure.

FIG. 2 illustrates an example of a social network user page showing a feed with images and identifying a charity and a sponsor, according to an aspect of the present disclosure.

FIG. 3 is an example of a flowchart illustrating steps performed by the user for creating and sharing the album and selecting a sponsor, according to an aspect of the present disclosure.

FIG. 4 is an example of a flowchart illustrating steps performed by a sponsor for selecting a charity and a donation level, according to an aspect of the present disclosure.

FIG. 5 is an example of a flowchart illustrating steps performed by a charity for creating a campaign and selecting a donation maximum level, according to an aspect of the present disclosure.

FIG. 6 illustrates an example of a webpage displayed in a user's browser enabling the user to join a website associated with the feed server, allowing the user to join with another social network platform, such as Facebook, so that user actions on the second social network can be counted and so that the user can import pictures or other information between the first and second sites, and allowing charities to register with the website.

FIG. 7 illustrates an example of a webpage shown on a user's browser and provided by the website associated with a feed server, allowing the user to choose logging in or signing up with the social network platform provided by the feed server.

FIG. 8 illustrates an example of a charity rating guide and watchdog report available to users through the website associate with the feed server, according to an aspect of the present disclosure.

FIG. 9 illustrates an example of a charity page for the charity entitled “Bear Necessities,” the number of albums of the charity (four) and other organizations (Oxfam) or individuals that are “hugged” or “liked” or otherwise associated with the charity.

FIGS. 10-12 illustrate an example of a page displayed in a browser and associated with the charity “Bear Necessities,” showing e-books and albums of the charity, the number of e-books, albums, supporters, and corporate sponsors of the charity, providing images, logos, text about the charity, and enabling making a donation or becoming a sponsor of the charity, according to an aspect of the disclosure.

FIG. 13 is an example of a page for a user of the social network provided by the website associated with the feed server showing “hug notification” provided to the user listing people who have “hugged” various albums or e-books of the user, according to an aspect of the present disclosure.

FIG. 14 illustrates an example of “badges” that may be earned by a user based on the number of user actions or other activities, according to an aspect of the present disclosure.

FIG. 15 illustrates an example of a user page provided in the user's browser by the website associated with the feed server showing a number of comments (two thousand), “hugs” (fifty) and shares (six hundred) for an e-book of the user.

### DESCRIPTION OF THE DISCLOSURE

Described is an online platform or website that enables a user to create a virtually interactive album, photo album or electronic book that can be shared with other users on the site and/or with one or more social network platforms, such as Facebook, that is used by the creator of the photo album.

Corporate sponsors can be enabled to support charity campaigns in a convenient manner as follows: an interactive album or e-book is created by a user and provided as a feed to friends or connections on a social network of the user, and upon clicking like, a donation, such as one dollar, is made to the charity noted by a corporate sponsor. That is, for each “like” on the social network site, and for each “hug” on a website associated with the feed server, which may too provide a social network (sometime referred to herein as the “first social network”) a set amount of money is donated to a charity. A donation limit or maximum may set by a corporate sponsor who is donating the money.

The corporate sponsor selects in advance the charity or charitable campaign to which it wishes to donate and the maximum amount of the donation. The name of the charity campaign or the name of the charity, the logo of the charity and/or campaign, a slogan of the charity and/or campaign and the like, and the name of the corporate sponsor, and the corporate logo, slogan, and the like are shown as part of a “feed” received by friends or connections on the social network of the user who creates the e-book and publishes the e-book or interactive album.

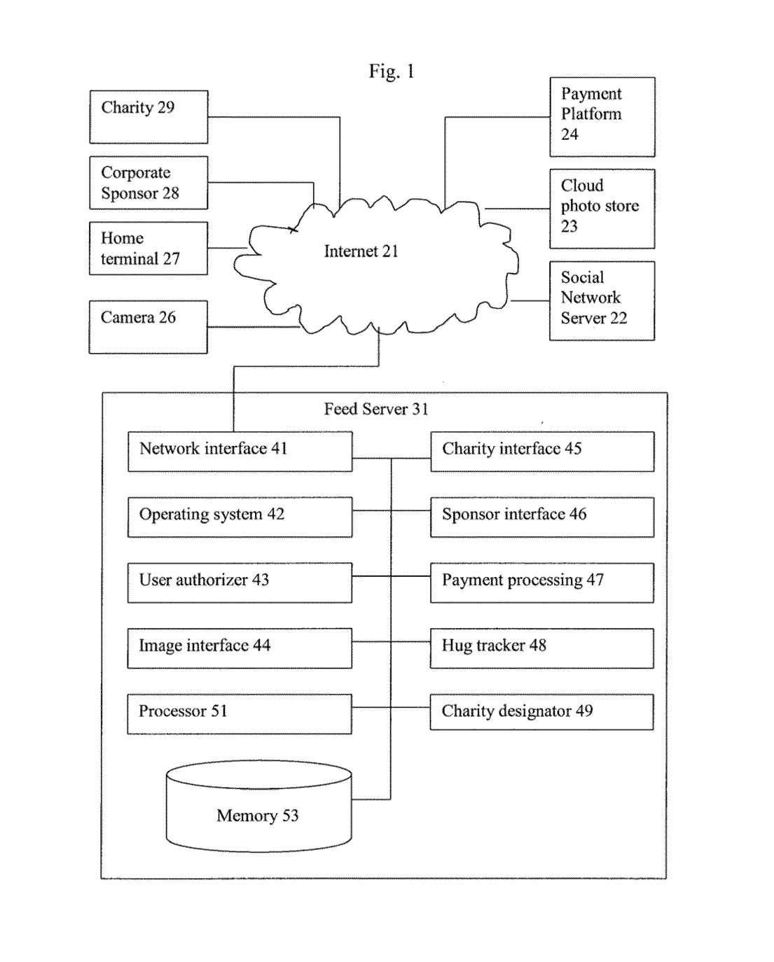

Users create and share photos and e-books by first taking photos using a digital camera or using a proprietary application or app developed for smartphones, such as iOS and Android operating systems to create a virtually interactive album, electronic photo album or e-book (“virtual album,” “photo album” or “e-book”). The album or e-book can thus be shared on many popular social media network sites. However, it will be understood that many types of photos stored in a user's home device or online can also be used to create the photo album or electronic book. A user can conveniently upload photos from a home computer or home terminal 27, a camera 26, such as a digital camera, smartphone, e-reader or other handheld or portable device via the Internet 21 to a remote feed server 31, as illustrated in FIG. 1. The photos can then be selected, associated with a virtual album or e-book, sorted, indexed, named or otherwise identified and tagged, managed, edited, ordered and/or laid out according to the user's preferences to create the virtual album, and then the virtual album can be shared on one or more social networks used by the user by pushing a feed of the album to the social network server 22. Similarly, the user can share photos from an online storage unit, cloud storage server, or an online photo album creation platform, such as Snapfish or the like, by visiting a website of cloud photo storage 23. Thus, the virtual album can be created using photos imported from one or more of a home terminal 27, camera 26 and the cloud photo storage 23. While described as a photo, it will be understood that any type of visual image, including digital representations of drawings, paintings or artwork, video footage or films in a variety of digital formats, sound clips and the like can also be uploaded and connected or associated with the virtual album. Such digital data can be used for a stand-alone feed independent of photos of visual information. For the sake of brevity, all such digital information used for feeds will be referred to herein as a virtual album or photo album or e-book.

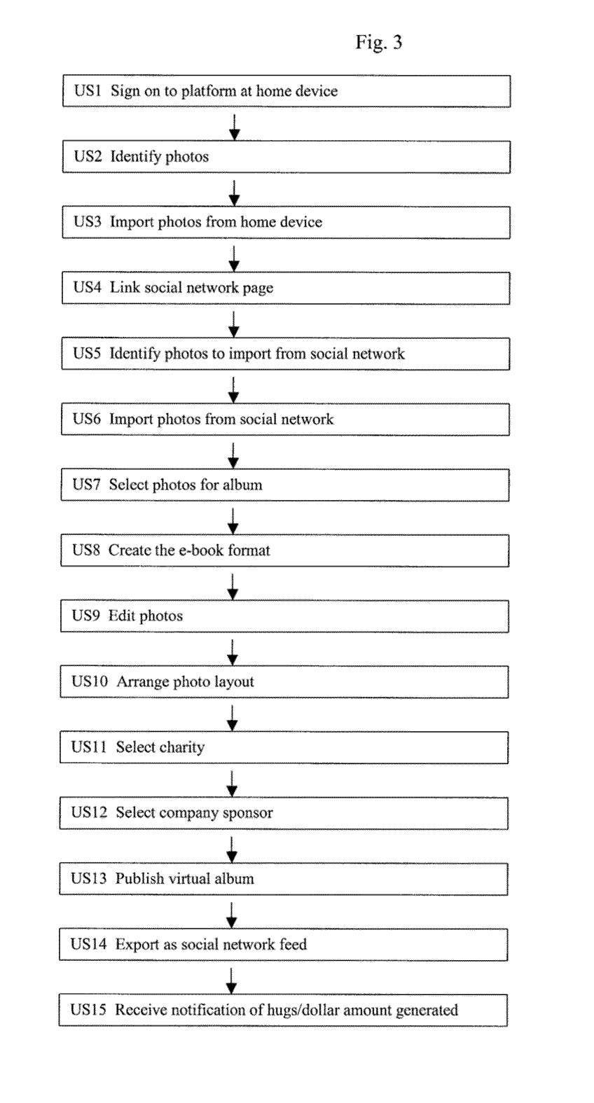

As illustrated at US2 in FIG. 3, the user identifies the photos stored on camera 26 or home terminal 27 that he or she wants uploaded to feed server 31. At US4, the user can also link a social network page such as a Facebook user account, from which the user wants to import photos or other digital content to feed server 31 for the virtual album. For example, the user may wish to import all his or her photos from the Facebook account to feed server 31, or only some photos that he selects. In addition, the user may wish to import photos onto feed server 31 from a cloud photo store 23 such as an online data storage or the like. At US6, the user imports the photo selected from a social network onto the feed server 31. At this point the user has imported all the photos he or she needs to create the virtual album or e-book. At US7, the user selects from the photos available the photos he or she would like to use for a particular virtual album or photo album.

User at US8 creates or selects the e-book format that he wishes from a range of options provided by the feed server 31, such as size, name, format, the number of pages, colors, background, style and the like. At US9, the user may wish to edit the photos, such as by cropping, resizing, removing red-eye or doing other operations on the photo to clarify or otherwise enhance the look of the photos. At US10, the user arranges the photos according to a selected photo layout in the album or book, and thus the user has created his or her interactive album or e-book.

The user at US11 can select a charity or a charity campaign of a charity to which he wishes donations to be made. For example, feed server 31 includes charity interface 45 that allows charities to provide their information, campaign information, their logos, slogans and visual images to be associated with the campaign or the like. Feed server 31 includes memory 53 that may store such information for thousands of charities and charity campaigns. The user can be given the option of selecting one or more of such charities or charity campaigns either topically, for example, cancer research, or by geographic region, alphabetically or the like.

The charity may create a charity virtual album or e-book containing photos, images or other information for the charity or for a charity's campaign to highlight the charity or the charity campaign's work, services, need for funds, awards received and/or impact or the like. Such a charity photo album or e-book can be shown as a feed to users, for example, to friends of a user who associates the charity's virtual album or e-book with his own virtual album or e-book. That is, when the user wishes to share his virtual album or e-book he may also be prompted to select, or may on his own initiate select, a charity virtual album or e-book. Thus, the user's virtual album or e-book may be shown together with, just after or just before, adjacent to or close in proximity to the charity's virtual album or e-book in the feeds of the user's friends. Similarly, the charity's or the charity campaign's virtual album or e-book may be shown together with, just after or before, or next to or in close proximity to the user's virtual album or e-book on a different social network such as on Facebook, Myspace, Flickr, Picasa or the like, as part of the feed or newsfeed for the user or the user's friends or the user's friends' friends or the like.

The donation may be calculated based on the total number of likes, received on Facebook or on one more other social networks, and on the first social network associated with the server or server bank where the virtual album or e-book was created and where the charity was designated by the first user. The total number of such hug, likes, other user actions indicating approval or affinity with the user image, or indicating liking, approval for or affinity with a comment or note or posting associated with or posted in response to the user image, is multiplied by a coefficient. The product is the dollar amount of the total donation generated by that user from the “pot” of money allocated by the corporate sponsor. It will be understood that amounts other than $1.00 may also be used.

In addition, users may choose to follow an album they really appreciate or love, and users will receive notifications for virtual albums or e-books that they have “followed.” In addition, users earn points for one or more of the following types of action: “hug,” “like,” or similar action and/or each “comment” and/or “share” and/or “follow” action, Sometimes any one or all of the foregoing social network actions is referred to herein as a “friend action,” on a friend's virtual album or e-book or on a charity's virtual album or e-book. Thus, interest may be generated in a charity's virtual album or e-book by lots of users hugging or liking or commenting or sharing or following the charity's or charity campaign's virtual album or e-book. Accordingly, by having users earn points for such actions, interest in the charity campaign can be enhanced.

Such user points can earn “badges,” “medals” or other honors for the user. A system of badges and medals, virtual and seen on the social network and/or on the site provided by or associated with the feed server, or physical badges and medals, can be created. Based on the total number of “likes” and/or “hugs” and/or “friend actions,” generated by friends of the user for any charity or charity campaign, or based on the total number of such friend actions over a period of time or over a lifetime, the user can be awarded such badges, medals and honors. The system can include badges and medals representing greater or lesser numbers of friend actions. Also, some friend actions, such as “share” may be worth more points for the user than other friend actions, such as “hug” or “like.”

An API (application programming interface) or other application or program of instructions may count the number of friend actions, such as “likes” or “shares” or the like of a virtual album or e-book on each social platform derived from feeds from the feed server. Then the social network provided by or associated with the feed server can post the tally of such actions for each charity, for each charity campaign and/or for each user.

A charity can invite corporate sponsors for each campaign or for the charity generally on the site provided by or associated with the feed server. For example, the charity can invite a sponsor to visit its webpage on the site provided by or associated with the feed server. Such a charity page on the site can also include a log for the charity, showing its timeline of content shared by users or sponsored by corporate sponsors. Such a timeline can be presented chronologically, by user, by charity campaign, by corporate sponsor or by some combination of the foregoing.

User may also be allowed to select a company sponsor that has provided money for the charity or charity campaign. That is, at US12 the user may wish to select a particular company that has provided an amount of money, such that with each “like” or “hug” of the news feed by a user of the social network platform, a set amount of money, such as one dollar will be donated to the charity from a previously set amount provided by the corporate sponsor. At US13, the user publishes the virtual album or e-book so that other users can view it when visiting the website of feed server 31.

At US14, the user may wish to export to one or more social networks with which the user is registered the interactive virtual album or e-book, or just to export images from such virtual album or e-book, as a feed to the social network. Thus, for example, the user may wish to select Facebook and/or MySpace or the like, and then the album or portion of the album will appear as a feed to all friends or connections of the user on Facebook and/or MySpace. As each of user's friends or connections on the social network views the image or images of the feed, such friend or connection may “like” or “hug” the image or album provided as a feed, and a dollar or some other pre-specified amount is then donated to the charitable campaign from the “pot” or preset amount of money set up or allocated by the corporate sponsor. At US15, the user can receive notification of the hugs or dollar amounts generated by the feed.

The operation of the feed server 31 will now be described with reference to FIG. 1. Network interface 41 of feed server 31 illustrated in FIG. 1 connects to Internet 21 and handles messaging or communication with each of the components illustrated in FIG. 1. For example, messages may be conducted using TCP/IP or some other protocol. Operating system 42 runs Feed server 31, and User authorizer 43 serves to authenticate the user, handle user registration and the like. Image interface 44 allows the user to upload images, to select formats, styles, sizes and the like of a virtual photo album or e-book, and to arrange and to lay out the images to create the photo album.

Charity designator 49 of Feed Server 31 allows a user to browse the various charities that have registered with the site, provided information to the site or the like, and to associate one or more charities or charitable campaigns or funds with a user image, e-book, virtual photo album or the like, that the user has uploaded or imported. A charity may also be allowed to request association with a user or user image or virtual photo album, and that request, if approved by the user, associates the charity or charitable fund, with the user or with the user image or virtual photo album. Although sometimes referred to as user image, it will be understood that this term may describe more than one user image viewable in sequence, simultaneously or as a collage or montage, a video or footage, a link, such as a hyperlink, or one or more images or videos accompanied by sound, music, text, explanation, or the like. Similarly, the charity identification accompanying the user image, and/or the sponsor information accompanying or displayed together with same may be one may include one or more of the foregoing.

Hug tracker 48 of Feed Server 31, also shown in FIG. 1, can keep track of the number of hugs, likes, shares or re-postings of the user image or virtual photo album or the like, and/or of comments on the user image, or of hugs, likes, shares or re-postings of one or more comments or response to the user image or virtual photo album, or other such user actions or feedback.

Such user actions performed on another, second, social network that the user has linked to the first social network can also provide a tally, in real time or upon reaching some predefined benchmarks, donation amounts, or time periods, and report back to Hug tracker 48 of Feed Server 31 the number of such hugs. For example, the hugs, likes, or other such user actions may be reported to Feed Server 31 each time a hug, like, etc. is clicked for the user feed, at set times, or when the number of hugs, likes, etc. reaches a predetermined number. For example, Facebook can be requested to provide automatically a number of “likes” clicked on a given user image of a particular user, and this number can be provided automatically to Hug tracker 48 of Feed Sever 31. Hug tracker 48 then tracks the number of hugs or likes received by feeds on the site associated with Feed Server 31, the social network or on more than one social network associated with the user. Processor 51 and memory 53 are provided as hardware elements, however it will be understood that feed server 31 may be configured as an array of servers, and that more than one processor 51 may be configured as part of feed server 31.

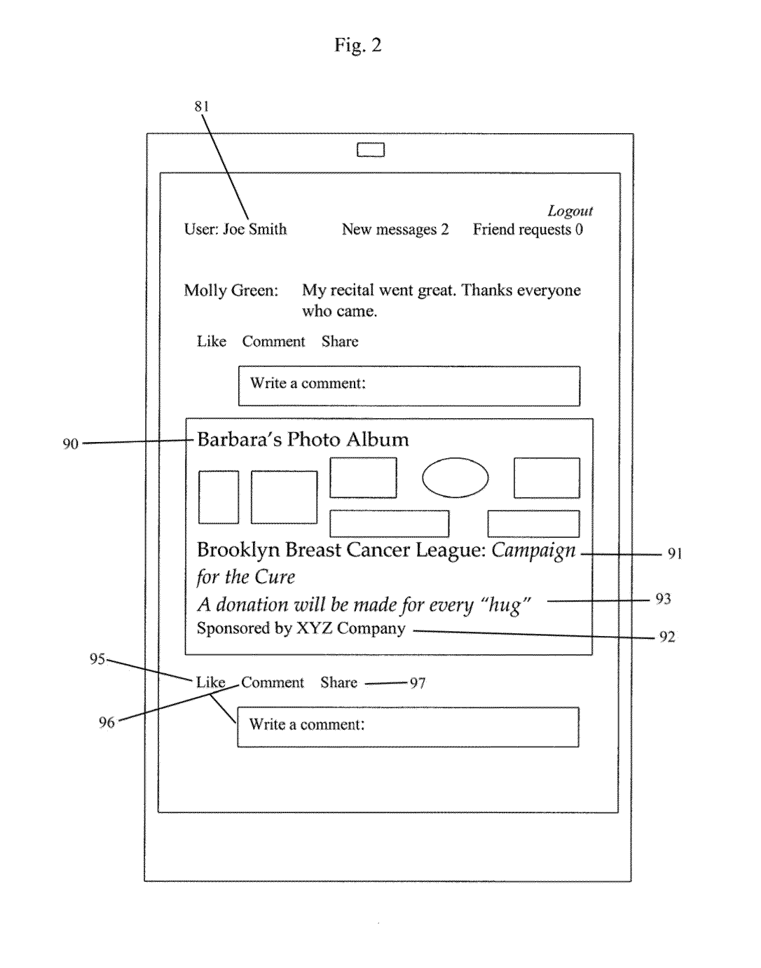

As illustrated in FIG. 2, Joe Smith is a user or member of a social network and is a friend or connection of user Barbara, who created the interactive album or e-book. On Joe Smith's page is displayed Barbara's feed based on Barbara's photo album or e-book. The feed also shows a charity, The Brooklyn Breast Cancer League, and a campaign, the “Campaign for the Cure,” associated with the selected charity. Thus, users who click “like” on the feed will cause a donation of a preset amount such as one dollar, 50 cents, $2, $5, $10, $20, $100 or some other previously specified amount, to be made to the charity. Such an amount for each hug or like can be selected by the sponsor and/or by the user creating the virtual album. It will be understood that a portion of the donation, such as 5 cents or 10 cents or the like for each dollar donated may be deducted as a processing fee for the payment platform and/or for the company maintaining the feed server and related system. In the alternative, sponsors may be required to donate a flat fee or a percentage greater than the charitable amount to be donated, which fee or percentage is then used to cover such payment platform and system expenses and profits. For example, a charitable donation by a sponsor of a $100 may require a donation of $110 or some other amount. The donation is provided by the XYZ Company. Alternatively, or in addition, users who “share” the feed on their own page on the social network, and/or “comment” on the feed also cause the donating of such an amount or another amount to the charity.

It will be understood that the charity and charity campaign and the sponsor can be shown as a separate feed before, after or adjacent the feed providing images of the virtual album or e-book. Thus, for example, Joe Smith's page may show a first feed with images from the virtual album or e-book created by Barbara, and then show a second feed that shows the name and logo of the charity, and/or charity campaign, and also shows the name of the sponsor. The number of likes or hugs generated thus far, or the amount so far donated to the campaign in connection with this feed, and/or the amount donated in total for all such feeds, can also be shown next to or as part of the feed. In addition, the amount remaining to be donated before reaching the maximum amount set by the sponsor, or the number of likes or hugs needed to reach the maximum amount set by the sponsor, can also be shown next to, as part of, or in connection with the feed. Such information can be provided in words and numbers or can be depicted using graphics or visual effects.

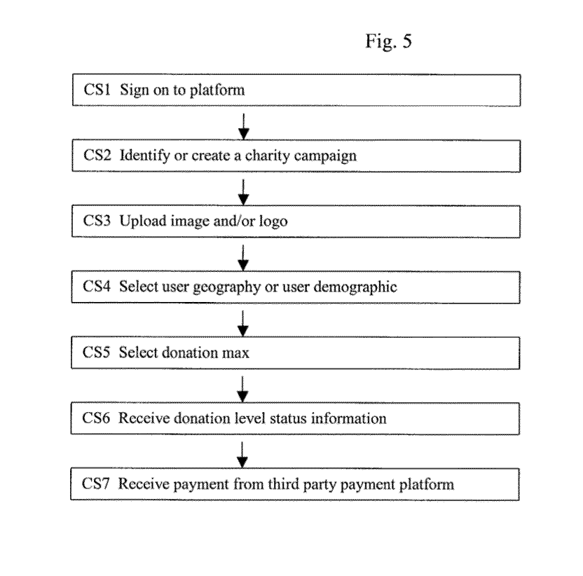

As illustrated in FIG. 5 is an example of a flowchart used by a charity to create a campaign or a presence on the platform.

At CS1, charity signs onto the platform or registers with the platform. At CS2 the charity identifies a charitable campaign or creates a new charity campaign to which users can associate their albums. At CS3, the charity can upload images or logos, video or other images to be associated with the charitable campaign. At CS4, the charity can select a geographic area or a user demographic or users who are eligible to associate their albums. For example, a local charity may wish to limit to restrict user participation to a certain local area or to a country or region, or may wish prevent a user from associating the charitable fund with user images. Similarly, a sponsor may wish to so limit users, for example, if the sponsor is interested in generating good will in a particular geographic area or among a particular social demographic or user category. It will be understood that this and other steps identified may be optional.

At CS5, the charity can select a donation maximum level for the campaign or for the charity as a whole. At CS6, the charity can receive donation level status information, identifying the amount of money that has been received or can receive the amount of money that has been allocated by sponsors as their maximum amount. At CS7 the charity receives payment from a third party payment platform that was used by the sponsor to make the donation.

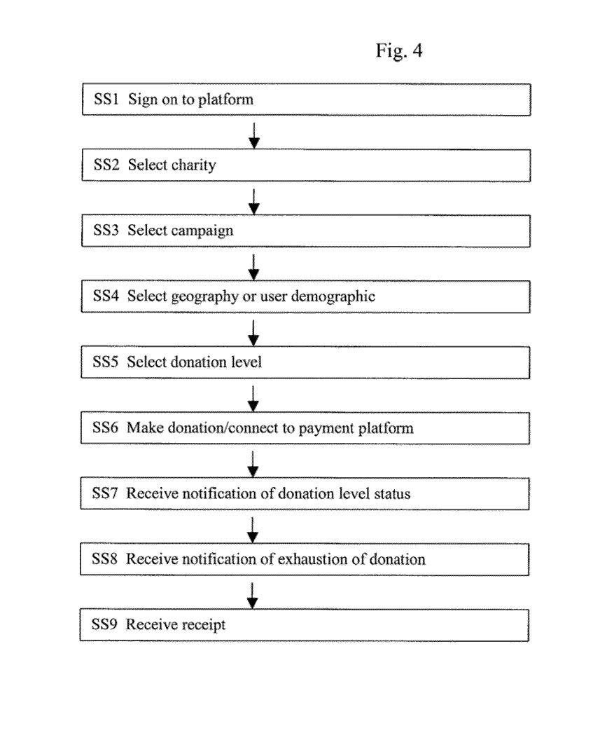

FIG. 4 illustrates steps of a process performed by a sponsor for creating sponsorship for a charity or charitable campaign. At SS1, the sponsor signs onto the platform or registers with the platform for the first time.

At SS2, the sponsor selects the charity to which the sponsor wishes to donate. At SS3, the sponsor selects a campaign of a charity to which the sponsor wishes to donate. Typically, many users, perhaps hundreds or even thousands, will wish to associated their feeds with any given charity campaign. It will be understood that more than one corporate sponsor may select the same charity or even the same charitable campaign. In such a case, a first one of the corporate sponsors will be associated with one or more user feeds associated with the charity campaign, and the second sponsor will be associated with a second set of user feeds associated with the charity campaign.

At SS4, the sponsor can select a geographic demarcation or user demographic demarcation of users who are eligible to participate. For example, the sponsor may wish to limit donations to users who are in the sponsor's geographic area, to the 16-24 age demographic, or to some other target demographic favored by the sponsor. Thus, only eligible users so identified can associate their feeds with a sponsor.

At SS5, the sponsor selects a maximum donation level at which the sponsor's contributions will be terminated for the campaign. At SS6, the sponsor makes a donation by connecting to a payment platform 24 (illustrated in FIG. 1). For example, a credit card company, a bank's on-line money transfer system, Paypal, Bitcoin or the like may be used as the payment platform. Alternatively, the donation may be performed later when the donation level is reached. If the maximum donation level is not reached because not enough users have liked or hugged the feed(s) within a previously specified time set by the corporate sponsor or within the time set by the charity for the campaign, then the donation is made only up the amount reached within the time.

At SS7, the sponsor receives notification of the donation level status, for example everyday or once a week or at pre-specified donation level, the sponsor receives notification that a particular number of users have clicked on like or on hug feeds associated with their sponsorship and the dollar amount so allocated. At SS8, the sponsor receives notification that the donation level has been reached and thus the amount donated has been exhausted. At this point, the payment platform may charge the donation of the sponsor. At SS9, the sponsor receives a receipt of the donation made.

A flowchart attached hereto as FIG. 3 describes steps that can be performed by the user to create a virtual photo album. At US1 (user step 1) the user signs onto the platform by visiting a URL associated with feed server 31. User may be authorized by being requested to present a username and password, or may be required to create a username and password if first joining the service.

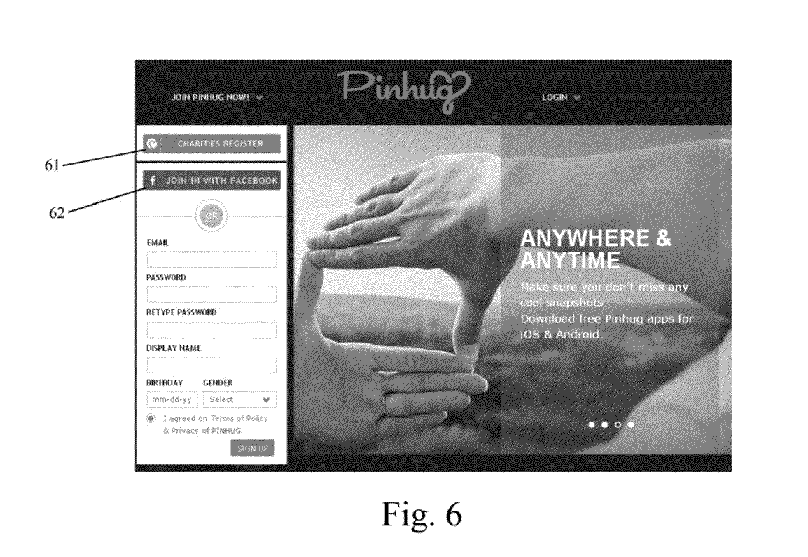

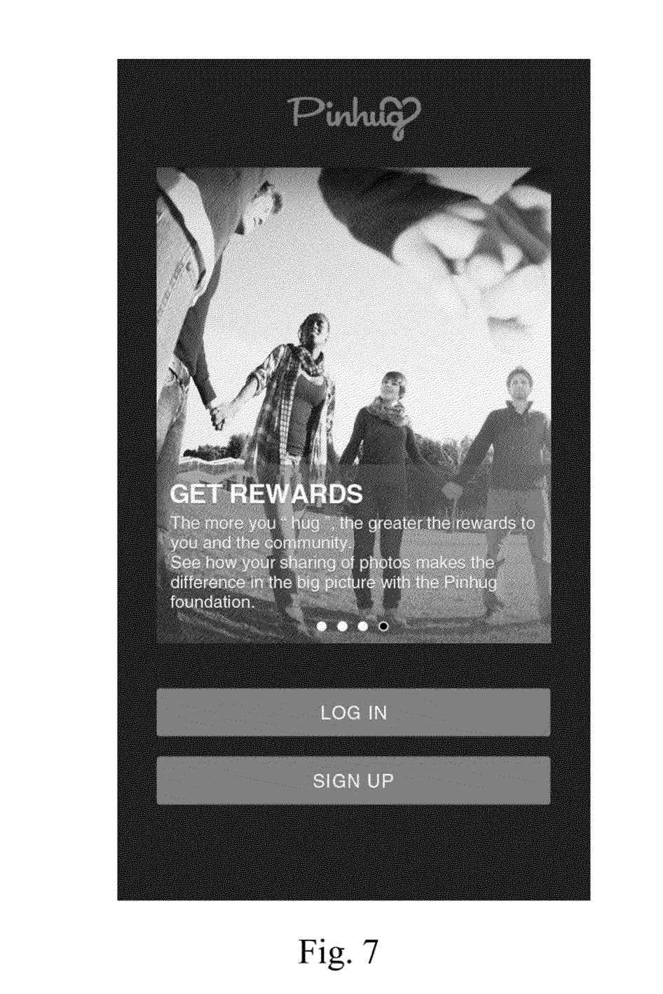

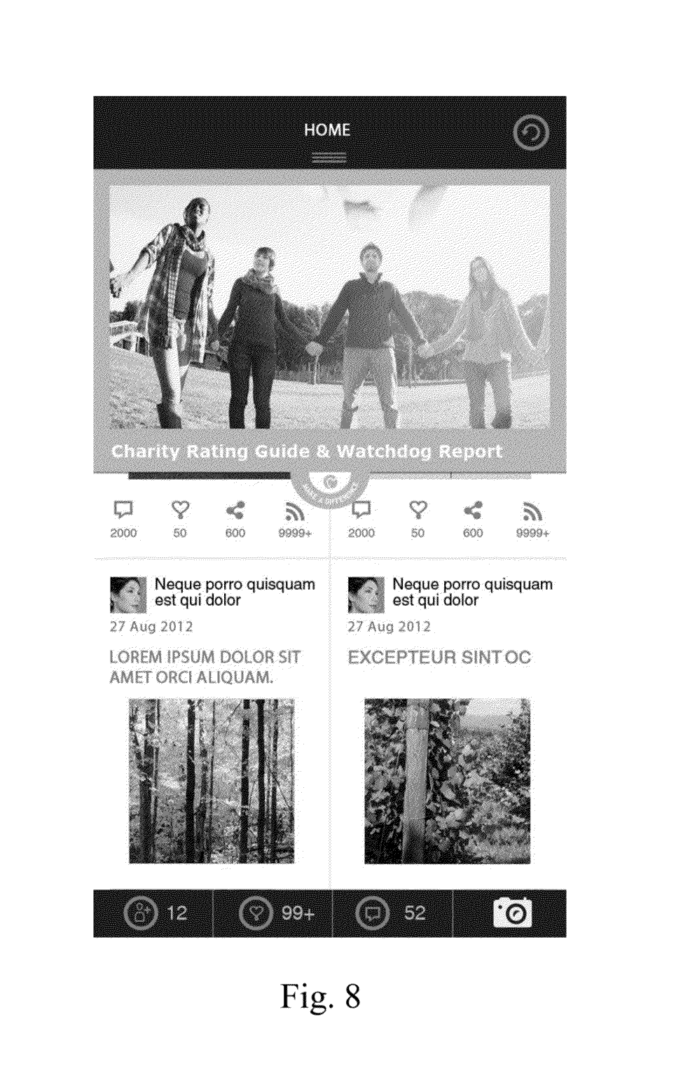

FIG. 6 illustrates a webpage that may be displayed to a user when joining a social network according to the disclosure to allow the user to share images and to designate charities. FIG. 6 illustrates bar 62, that allows the user to import contacts or “friends” from another social network, such as Facebook. Linking with the second social network (and, optionally, with a third social network) may also allows the user in a convenient manner to import images, photos or photo albums from the other social network, and to instruct the server of the social network to supply a feed of the user image to the second social network. FIG. 6 also illustrates bar 61, that upon being clicked, or otherwise selected, allows the charitable organization or not-for-profit organization to register itself or a campaign or fund thereof, with the social network.

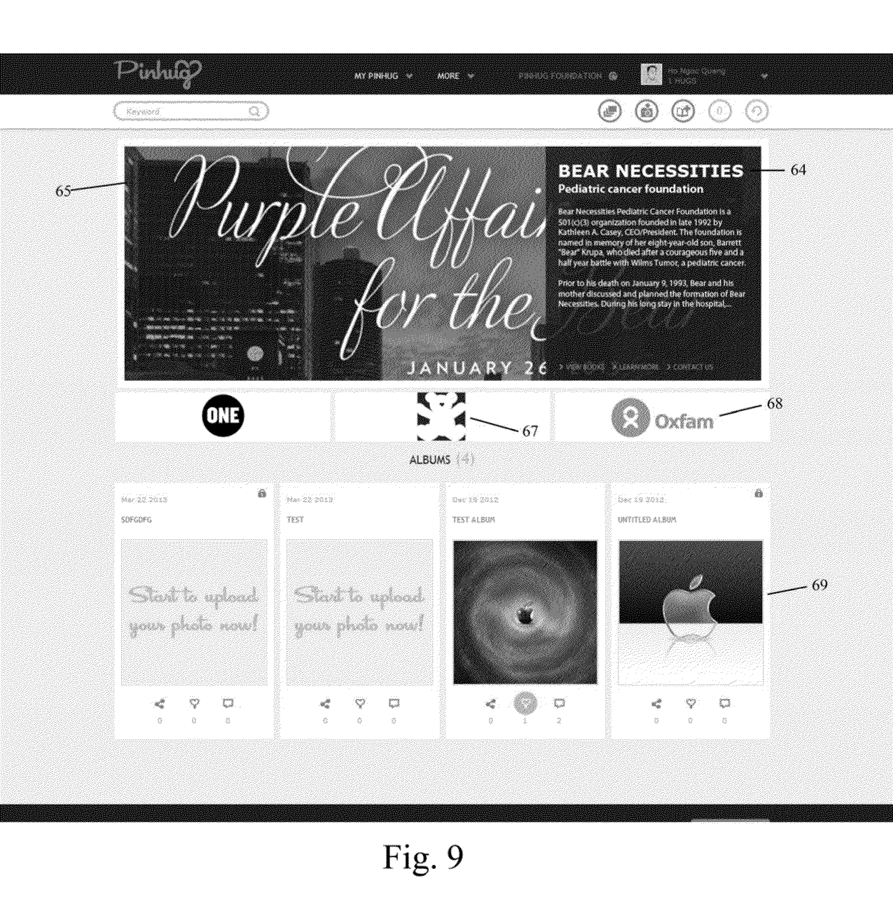

FIG. 9 illustrates an example of a charity campaign that has been registered by a charitable organization with a social network. The charitable campaign, named Purple Affair for the Cure, is illustrated as part of a display 64 identifying the charity named Bare Necessities. The page also shows the number of photo albums 67 of the charity campaign, and organization section 68 lists other organizations connected with or doing similar work to the charity or linked by users to the charity and individual members of the social network who have connected with or “hugged” or “liked” the charitable campaign or sponsors who have been linked by users as donors to the charitable campaign.

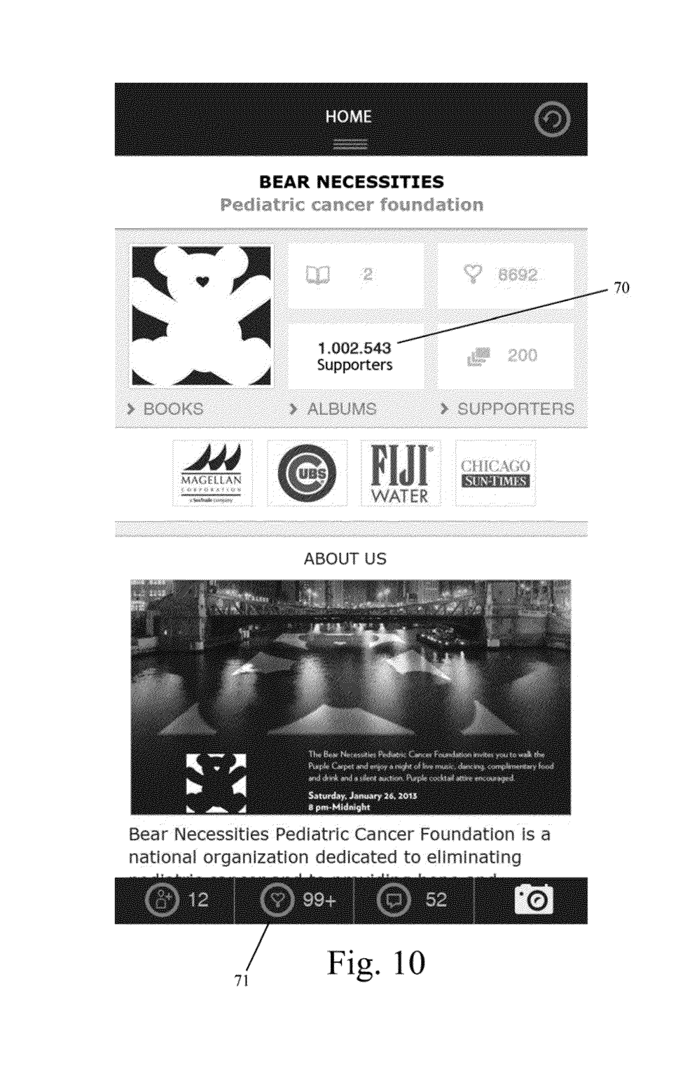

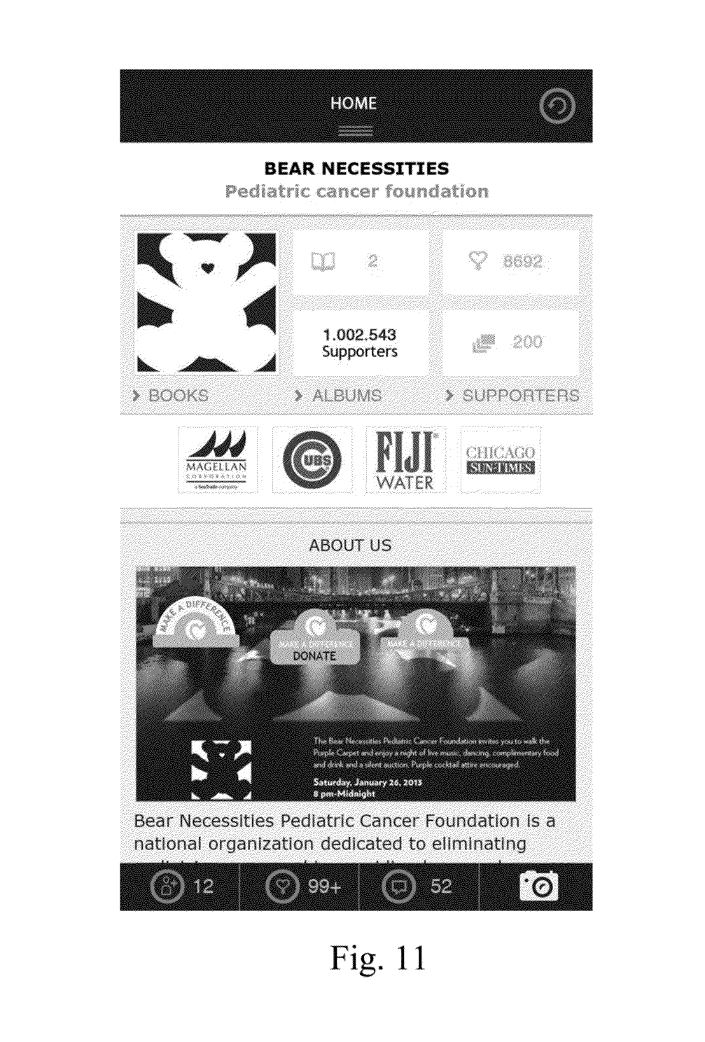

FIG. 10 illustrates a webpage of the social network showing a charitable fund, the Bear Necessities Pediatric Cancer Foundation as the charity, the number of supporters, or users or the charitable campaign that have linked their user images or virtual electronic books or photo albums to the charitable campaign such that user action generates donations, supporter display 71, information about the charitable campaign 70 and other information.

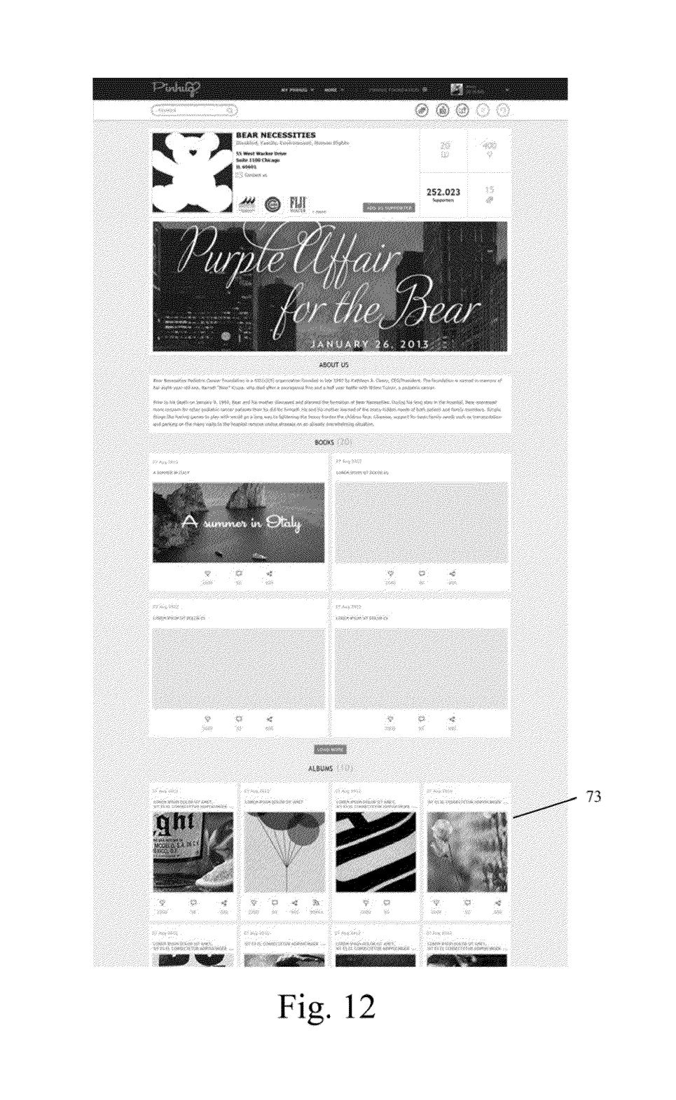

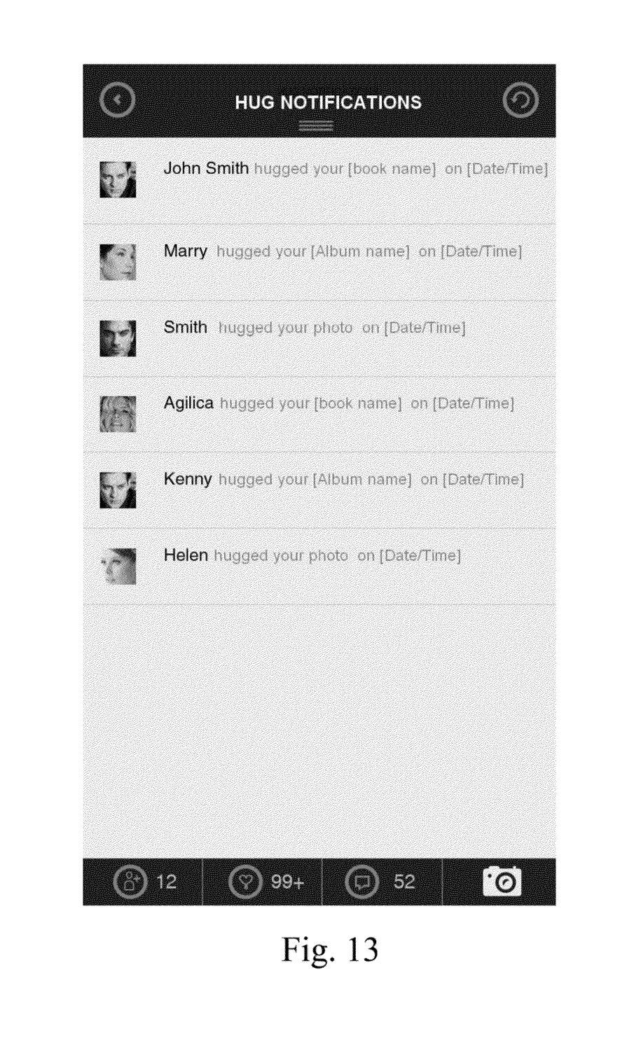

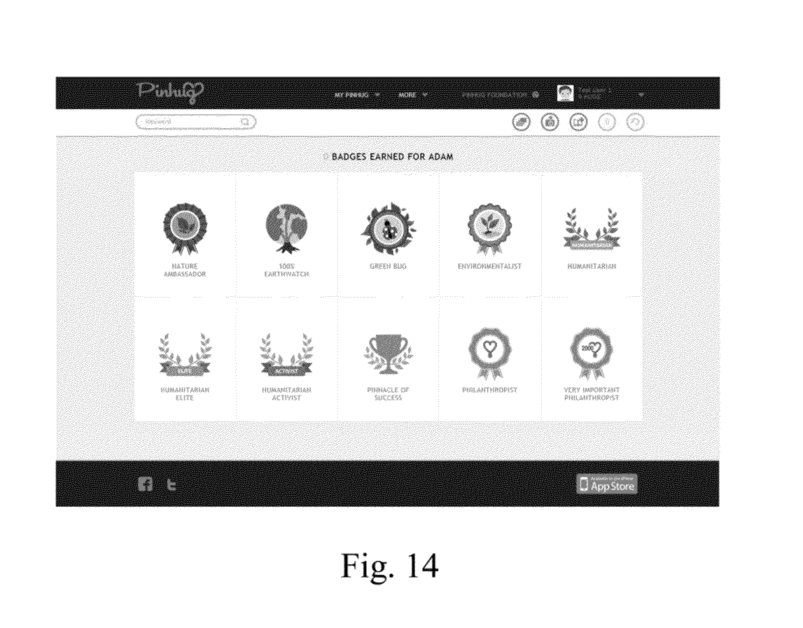

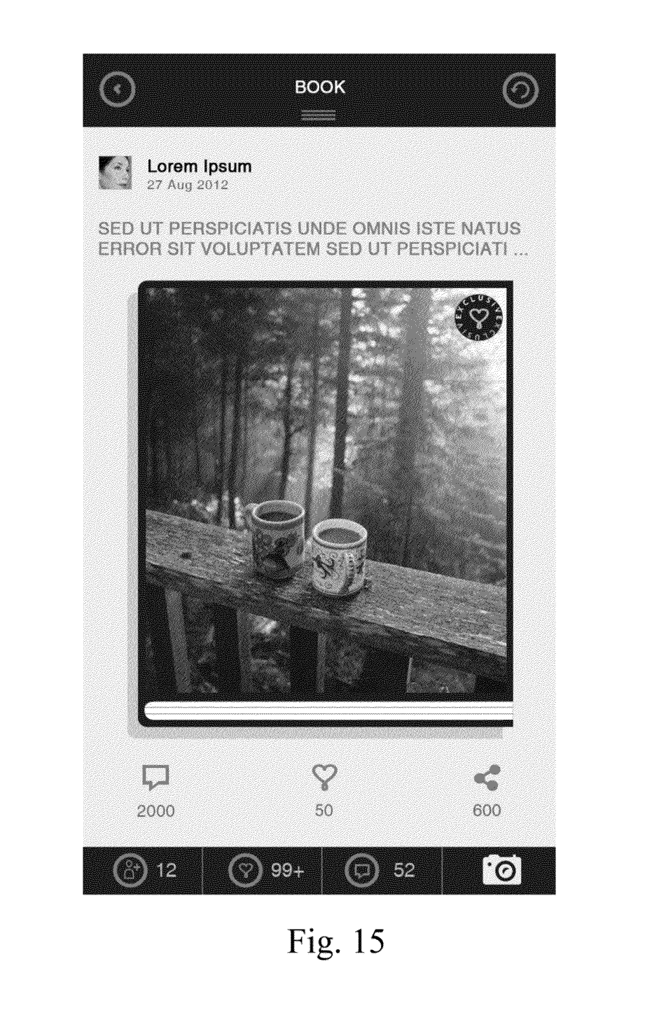

FIG. 12 illustrates a user album section 73 of images or virtual photo albums of the users of a social network who have linked with the charity, for example, to set up donations based on user actions on the social network.

According to another aspect of the disclosure, user actions performed on a second social network may be counted and used to generate donations for charity. Thus, a user of the first social network can link another social network of the user as a member.

FIG. 2 illustrates that the user that has signed up with the second social network and has designated a charity connecting himself or herself or connecting the user's virtual photo album or user image with a charity or charitable campaign or charitable fund on the social network also has a page on a second social network. Thus, connections of the user on the second social network can view feeds of the user on the second social network. For example, in FIG. 2, user Joe Smith of the second social network is connected to the first user, Barbara, who is both a member of the social network and the second social network. In this way, Joe Smith, who may be a user or registered member of only the second social network (or of both the first and second social networks), is provided a feed of user Barbara's photo album, together with an identification of the charitable campaign, Brooklyn Breast Cancer League: Campaign for the Cure. An identification of the sponsor, XYZ Company, and the explanation that the donation would be made for every “hug” of the user actions, such as like comment on the feed, sharing of the feed may also be counted as a user action on the network that causes donations to be made. In FIG. 2, user is identified in user identification field 81 and the user image, in this case the virtual photo album is shown in feed 90. Feed 90 also includes the identification of the charitable campaign 91, the identification of the sponsor 92, and the explanation 93 that a donation would be made for every user action. User actions 95-97 are illustrated as an approval action 95, comment action 96, and a share or reposting action 97. One or more such user actions may be counted as user actions that drive charitable donations by the sponsor. Which such user actions are counted depends on user setting entered by the first user, in this case Barbara, by the Sponsor, by the Charitable fund or charity, or may be set by default by the social network.

Home terminal 27 may be any type of computer, cable of communicating with a second processor, including a laptop, notebook, netbook, smartphone, e-reader or other hand held device or tablet. Camera 26 can be run on iOS and Android, and can be telephones or smartphones, and handheld and portable devices. Feed server 31 may be an Apache web server may running on LINUX. However, it will be understood that other systems may also be used. Feed server 31 may be thought of as a traditional server, however, it may be comprised of one or more processor-driven devices, including portable devices. Further, home terminal 27 may be a stand alone computer or may be provided as part of a system of several devices working in tandem, or may integrate the functionality of a number of devices, including a modem, a wireless router, an ISDN interface or the like.

Described herein is a method, non-transitory computer-readable medium incorporating a program of instructions, means for, device, and system that provides the user-action driven support functionality described herein. The computer-readable medium may include instruction configured as software, hardware, or firmware, or combination of the foregoing, for example, one or more or all of the feed server 31 illustrated in FIG. 1, or any component that provides one or more of the functionalities, or any portion of a functionality, described herein. The means for may be any component that provides one or more of the functionalities, or any portion of a functionality, described herein. A device may be a device that includes or executes such software, hardware or firmware. A computer system may include one or more processors in one or more physical units that includes such a device, or that performs such a method, or that executes the computer-readable medium, according to the present disclosure.

The present methods, functions, systems, computer-readable medium product, or the like may be implemented using hardware, software, firmware or a combination of the foregoing, and may be implemented in one or more computer systems or other processing systems, such that no human operation may be necessary. That is, the methods and functions can be performed entirely automatically through machine operations, but need not be entirely performed by machines. Similarly, the systems and computer-readable media may be implemented entirely automatically through machine operations but need not be so. Computer systems as described herein may include one or more processors in one or more units for performing the system according to the present disclosure and these computers or processors may be located in a cloud or may be provided in a local enterprise setting or off premises at a third party contractor. Similarly, the information stored may be stored in a cloud or may be stored locally or remotely.

The computer system or systems for interacting with a user can include a GUI (Graphical User Interface), or may include graphics, text and other types of information, and may interface with the user via desktop, laptop computer or via other types of processors, including handheld devices, telephones, mobile telephones, smart phones or other types of electronic communication devices and systems. A computer system for implementing the foregoing methods, functions, systems and computer-readable storage medium may include a memory, preferably a random access memory, and may include a secondary memory. Thus, although illustrated as a system database, the database may be part of the same machine or may be located off site, and may be implemented as a floppy disk drive, magnetic tape drive, an optical disk drive, removable storage drive, a combination of the foregoing or any type of recording medium. Examples of a memory or a computer-readable storage medium product include a removable memory chip, such as an erasable programmable read-only memory (EPROM), a programmable read-only memory (PROM), removable storage unit or the like.

The communication interface may include a wired or wireless interface communicating over TCP/IP paradigm or other types of protocols, and may communicate via a wire, cable, fire optics, a telephone line, a cellular link, a radio frequency link, such as WI-FI or Bluetooth, a LAN, a WAN, VPN, the world wide web or other such communication channels and networks, or via a combination of the foregoing.

While the preferred embodiments of the invention have been illustrated and described, modifications and adaptations, and other combinations or arrangements of the structures and steps described, come within the spirit and scope of the application and within the claim scope.

What is claimed is:

1. A network user action-driven support computation method, comprising:
receiving, from a first device connected to the network, a user image viewable on a plurality of second devices connected to the network;
receiving, as a first association, a designation by a first user associating a charitable fund with the user image;
obtaining automatically, as a first value, a number of network user actions, entered on the plurality of second devices, to the network for the user image;
computing automatically, as a donation amount, the network user action-driven support for the charitable fund according to a product of a coefficient and the first value; and
outputting automatically the donation amount via the network.

2. The method of claim 1, wherein the user image is viewable as a feed provided, by at least one server computing device of a social network, on a page associated with a social network user, and the network user actions are actions by social network users responding to the user image.

3. The method of claim 2, wherein the network user actions comprise likes or hugs of the user image provided to social network users connected on the social network to the first user.

4. The method of claim 2, wherein the network user actions comprise shares or re-postings of the user image provided to social network users connected on the social network to the first user.

5. The method of claim 1, wherein, based on the first association, the user image is displayed on the plurality of second devices adjacent to or juxtaposed with an identification of the charitable fund.

6. The method of claim 5, wherein the identification of the charitable fund includes a disclosure that the network user actions entered for the user image generate donation to the charitable fund.

7. The method of claim 1, wherein the user image is a virtual photo album or a representation of a virtual photo album.

8. The method of claim 1, further comprising:
receiving, from a sponsor, as a maximum value, a maximum support amount that the sponsor commits to giving to the charitable fund;
charging the sponsor a charged amount, the charged amount being the donation amount up to the maximum value; and
making a donation to the charitable fund based on the charged amount.

9. The method of claim 8, further comprising:
subtracting from the charged amount a fee amount to yield a net donation amount,
wherein the making the donation comprises giving the net donation to the charitable fund.

10. The method of claim 8, wherein, based on the first association, the user image is displayed on the plurality of second devices adjacent to or juxtaposed with an identification of the charitable fund; and
further comprising:
displaying an identification of the sponsor adjacent to or juxtaposed with the identification of the charitable fund.

11. The method of claim 10, wherein the identification of the sponsor includes displaying the maximum value.

12. The method of claim 5, further comprising displaying a tally in real time of network user action-driven support generated for the charitable fund.

13. The method of claim 5, further comprising displaying a tally in real time of network user action-drive support generated for the charitable fund in response to the user image.

14. The method of claim 1, further comprising:
displaying identification of a plurality of charitable funds; and
receiving, from the first user, the designation associating the charitable fund with the user image, a selection of the charitable fund from the plurality of charitable funds.

15. The method of claim 1, wherein the user image is received directly via the internet from a second server computing device of a second social network in response to a user instruction.

16. The method of claim 8, wherein the coefficient is a pre-set amount designated by the sponsor.

17. The method of claim 2, further comprising:
receiving from a sponsor as a maximum value, a maximum support amount that the sponsor commits to giving to the charitable fund; and
receiving from the sponsor a user restriction restricting a type of user who is permitted to serve as the first user.

18. The method of claim 17, wherein the user restriction identifies the type of first user by geographic region.

19. The method of claim 17, wherein the user restriction identifies a type of first user by a demographic criterion.

20. The method of claim 1, further comprising:
calculating a total number of network user actions entered for the first user in connection with the user image and all user images associated with the first user with which a charitable fund has been associated; and
awarding a virtual badge, a virtual medal or a virtual citation viewable on the page associated with the first user, when the total number of network user actions reaches a pre-set amount.

21. A network user action-driven support computation system, comprising:
a user image interface configured to receive a user image from a first user;
a designation module configured to receive, as a first association, a designation by the first user associating a charitable fund with the user image;
a feed provider configured to provide the user image viewable as a feed of a social network provided to a plurality of social network users connected on the social network to the first user;
a user action tracking module configured to obtain automatically, as a first value, a number of network user actions entered by the plurality of social network users,
wherein the network user actions are actions by the plurality of social network users responding to the user image and comprising at least one of likes, hugs or user actions expressing approval of the user image;
a donation tracking module configured to compute automatically, as a donation amount, the network user action-driven support for the charitable fund according to a product of a coefficient and the first value; and
the donation tracking module further configured to output automatically the donation amount via the network.

22. The system of claim 21, wherein, based on the first association, the feed provider provides the user image for display on the plurality of second devices adjacent to or juxtaposed with an identification of the charitable fund.

23. The system of claim 21, wherein the user image is a virtual photo album or a representation of a virtual photo album.

24. The system of claim 21, further comprising:
a sponsor interface configured to receive, from a sponsor, as a maximum value, a maximum support amount that the sponsor commits to giving to the charitable fund; and
a payment processing module configured to charge the sponsor a charged amount, the charged amount being the donation amount up to the maximum value,
wherein the donation amount to the charitable fund is based on the charged amount.

25. The system of claim 21, wherein, based on the first association, the feed provider provides the user image for display on the plurality of second devices adjacent to or juxtaposed with an identification of the charitable fund; and
the feed provider provides with the user image for display an identification of the sponsor adjacent to or juxtaposed with the identification of the charitable fund.

26. A method of generating network user support for a charitable fund, the method comprising:
receiving, from a first device connected to the network, a user image associated with a first user of a social network, the user image viewable by a plurality of second users, the plurality of second users being connections on the social network of the first user;
displaying an identification of a plurality of charitable funds to the first user;
receiving, from the first user, as a designation associating a charitable fund with the user image, a selection of the charitable fund from the plurality of charitable funds; and
displaying together an identification of the charitable fund and the user image as a feed viewable by the plurality of second users on a page of a social network associated with each user of the plurality of second users.

27. The method of claim 26, wherein the user image is a virtual photo album or representation of the virtual photo album.

28. The method of claim 26, wherein the user image is imported to at least one server computing device associated with the social network from a first device operated by the first user, in response to an instruction entered by the first user.

29. The method of claim 26, wherein the user image is imported to at least one server computing device associated with the social network from a second device remote from the first user and connected to the first user and to the server device associated with the social network via the internet.

30. The method of claim 26, wherein the user image is imported to the server computing device associated with the social network from a second server device associated with a second social network different from the social network.

31. The method of claim 26, wherein the displaying together comprises displaying the identification of the charitable fund adjacent to or juxtaposed with the user image.
